(19) United States
(12) Patent Application Publication
(10) Pub. No.: US 2006/0096473 A1
(43) Pub. Date: May 11, 2006

(54) Device for engraving of cups into printing cylinders by means of laser light

(76) Inventors: Siegfried Beisswenger, Preetz (DE); Peter Ressel, Schonkirchen (DE)

Correspondence Address: SCHIFF HARDIN, LLP;PATENT DEPARTMENT, 6600 SEARS TOWER, CHICAGO, IL, 60606-6473, US

(21) Appl. No.: 11/117,204

(22) Filed: Apr. 28, 2005

(30) Foreign Application Priority Data
May 5, 2004 (EP) 04010675.9

(51) Int. Cl. B44B 5/00

(52) U.S. Cl. 101/3.1

(57) ABSTRACT

In a device for engraving of cups into a rotating printing cylinder for rotogravure, at least one laser light source with which laser light for formation of the cups is directed onto the rotating printing cylinder. A metal removal element is arranged in a region of an impingement location of the laser light on the printing cylinder to form the cups such that a melt accumulation of material of the printing cylinder which forms a burr at the cups created by the impingement of the laser light is removed substantially continuously and substantially immediately after its creation with the removal element.

### BACKGROUND

The preferred embodiment concerns a device for engraving of cups into printing cylinders for rotogravure comprising at least one laser light source by means of which the laser light is directed on the printing cylinder (thereby driven such that it rotates) to form the cups. An exit of the laser light source is constantly moved in the axial direction of the printing cylinder dependent on the rotation of the printing cylinder or an exit of the laser light source is respectively moved by a predetermined amount in the axial direction of the printing cylinder after completion of a complete rotation of the printing cylinder.

A device is known for engraving of cups for rotogravure (unpublished European patent application 04 004 470.3). In the formation of the cups, burrs are created in the border area of the cups (towards the printing cylinder in which the cups are formed), both in the engraving of printing cylinders for rotogravure by means of a mechanical engraving member (for example a diamond engraver) and in the engraving of printing cylinders for rotogravure by means of laser light. The burrs compulsorily created at each mechanically-engraved cup are either: 1) removed in a special work process (after conclusion of the complete engraving of the printing cylinder) via two-dimensional deburring of the entire printing cylinder circumference in which the cups have been formed, and these cups are subsequently polished if necessary, or: 2) a metal removal device runs at a certain distance following and offset from the engraving member, if necessary synchronized with this with regard to the axial movement of the engraving member along the printing cylinder, such that the surface of the printing cylinder charged by the metal removal member is deburred at a certain interval in the axial direction after the mechanical engraving member in the course of the rotation of the printing cylinder.

These methods of deburring of cups formed by means of mechanical engraving is possible in the form described in the preceding only given a mechanical engraving of the cups.

The methods of deburring described in the preceding fail, given the engraving of cups in printing cylinders by means of laser light. This has as its significant reason that a cup produced by means of laser light, due to the liquefaction of the material and its vaporization in the course of the charging of the surface of the printing cylinder (which is comprised of metal at least in the surface region), has a specific edge bead that stands out from the actual surface of the metallic printing cylinder, which is always formed in the border area of the cup formed by means of laser light, and is in fact created by the melting of the metal and the vaporization of the metal in the center of the laser light beam. Due to the beam profile of the laser beam, the border area is merely melted, such that a part of the metal melted in the center of the beam profile (namely the part that is not vaporized) accumulates there.

In high-resolution laser engraving a plurality of cups (for example 50 and more cups) must be formed on the same surface of the printing cylinder on which previously a single cup could be formed by means of mechanical engraving, since the tracks in which the laser light impinges around the circumference of the printing cylinder to form the high-resolution plurality of cups lie very close to one another in the axial movement direction of the laser light along the printing cylinder. Given laser engraving, after an engraving in one track around the printing cylinder, the adjacent, finished engraved track would be impaired by the aforementioned melt accumulation at the beginning of the next track. Thus the engraving in the preceding track would be unusable since the cups previously formed in the preceding track partially close again due to the melt accumulation of the subsequent track, however, would be impaired at least with regard to the cup contour such that a printing cylinder so engraved with laser light would deliver defective print results.

Many attempts have been made in this context, for example, to focus the beam profile of the laser light and to confine it via diaphragms such that the melt accumulation is no longer so serious. However, this normally has the result that the effective emitted power of the laser light was also limited at the impinging location on the printing cylinder, such that the intended high-resolution laser engraving inherently possible by means of the laser light was again significantly limited with regard to the good engraving results thereby achieved.

### SUMMARY

It is thus an object to achieve a device previously cited type with which a high-resolution engraving with very satisfactory print results of the engraved printing cylinder is possible by means of laser engraving, and that elaborate deburring measures for the finished, engraved printing cylinder are foregone. Thus the finished, engraved printing cylinder is substantially ready for the subsequent printing event after conclusion of the laser engraving. Thus the production expenditure of the printing cylinder produced for the printer can be significantly reduced relative to the processes for its production, whereby the device can in principle be executed in a simple manner and also can be equipped in devices known in the prior art via corresponding retrofitting in the sense of the preferred embodiment.

In a device for engraving of cups into a rotating printing cylinder for rotogravure, at least one laser light source with which laser light for formation of the cups is directed onto the rotating printing cylinder. A metal removal element is arranged in a region of an impingement location of the laser light on the printing cylinder to form the cups such that a melt accumulation of material of the printing cylinder which forms a burr at the cups created by the impingement of the laser light is removed substantially continuously and substantially immediately after its creation with the removal element.

### BRIEF DESCRIPTION OF THE DRAWINGS

FIG. 1 shows in significantly schematized form, a device for engraving of cups into printing cylinders by means of laser light for formation of cups and a metal removal element that removes the burrs created as a melt accumulation after the formation of the cups;

FIG. 2 illustrates a unit comprised of a laser light source and an output unit via which the laser light exits, the laser light being directed onto the printing cylinder for execution of the engraving of cups;

FIG. 3 shows in the form of a block diagram, a unit by means of which laser light is generated and directed onto the printing cylinder;

FIG. 4 illustrates a schematized device for engraving of cups in a side view, whereby a laser unit and a metal removal element are arranged on a radially- and axially-movable carrier element that is designed as a type of support;

FIG. 5 shows in side view, the metal removal element in cooperation with the printing cylinder in enlarged representation;

FIG. 6 is a representation of the metal removal element in cooperation with the printing cylinder according to FIG. 5, however in plan view;

FIG. 7 is a representation of the metal removal element and of a support element in cooperation with the printing cylinder in plan view;

FIG. 8 illustrates a typical engraving raster with a plurality of cups generated by means of the high-resolution laser engraving; and

FIG. 9 is an enlarged representation of FIG. 4 with the engraving tracks indicated running in parallel of the preferred embodiment.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

With the preferred embodiment, a metal removal element is arranged in the region of the impingement location of the laser light on the printing cylinder, such that with this metal removal tool the melt accumulation of the material which forms a burr, which is created given the charging of the printing cylinder with laser light to form the cup, is continuously removed immediately after its creation.

The advantage of the preferred embodiment is essentially that the melt accumulation created on all sides of the cup is removed by means of the removal element from the engraving track virtually immediately after its engraving. The track is defined such that it either runs in a screw formation around the printing cylinder or runs strictly radially around the printing cylinder and, after execution of a complete rotation of the printing cylinder, a new track is begun, displaced by a corresponding width of the track in the axial direction of the printing cylinder, etc. Since, according to the preferred embodiment, the melt accumulation is removed on all sides of the cup immediately after the engraving of the cup in the axial direction of the printing cylinder, the melt accumulation of the first, finished engraving track on which the cups of the first engraving track lie is no longer hindering a new engraving track adjustment to the finished engraving track.

After completion of the engraving of the entire printing cylinder, the entire printing cylinder is thus rid of melt accumulation, i.e. from burrs, such that the printing cylinder can be used for its intended printing function virtually without post-processing.

The metal removal element virtually only needs to be associated with the track that is directly provided with cups by means of laser light in the course of the engraving member, or in which the cups are formed. However, embodiments of the invention are also possible in which a plurality of laser beams simultaneously charge a plurality of tracks in parallel to form the cups. In order to ensure that the melt accumulation thereby created per cup per track does not cause a hindrance to the adjustment track in the aforementioned sense, and thus insufficiently-engraved cups are created, it is advantageous to arrange the metal removal element immediately following in the region of the impingement location of the laser light on the printing cylinder in the rotation direction of the printing cylinder, such that the melt accumulation can be removed virtually immediately after the creation of the cup by means of laser light.

In principle, each laser light source for the purposes of the preferred embodiment, can have the requirement that it is capable of delivering a sufficiently high laser energy for execution of the engraving event. The laser light source can thereby be, for example, arranged displaced from the region of the impingement location of the laser light on the printing cylinder, whereby the generated laser light can, for example, be supplied to an optic for focusing of the laser light and, if necessary, can also be conducted for collimation of the laser light via a light conductor that is arranged immediately in the region of the impingement location of the laser light on the printing cylinder. Given this design, the light conductor can additionally also be designed as an active fiber laser in order to increase the energy of the laser light at the impingement location of the laser light on the printing cylinder.

With regard to the previously-posed object, it is advantageous in one preferred embodiment to design at least the light source and the output unit of the laser light (which, in the sense of the preceding statements, comprises the optic of the laser device) such that they can move in combination along the printing cylinder in its axial direction, i.e. the output unit of the laser light and the laser light source are advantageously comprised in a unit that can be moved back and forth in the axial direction on a support that is axis-parallel to the rotation axis of the printing cylinder. This embodiment has the advantage that the entire unit can be exchanged and replaced by a new one given malfunctions and maintenance, such that an interruption of the engraving event can be reduced to a minimum by means of this advantageous embodiment of the device, and the maintenance and servicing of the laser unit can be very significantly simplified.

Since the metal removal element for removal of the melt accumulation spatially correlates with the creation location, i.e. the location of the formation of the cup by laser-light charging, it is advantageous to design the removal element coupled (in terms of actuation) together with at least the output of the laser light, such that the removal element can move along the printing cylinder, such that a separate actuator of the removal element can be omitted in this advantageous embodiment of the device, and thus a separate controller of the removal element can also be omitted with regard to its movement in the axial direction relative to the printing cylinder. However, in principle it is also possible to decouple the movement of the removal element along the printing cylinder from the movement of the laser light along the printing cylinder, i.e. to provide it with its own actuator.

In principle, any suitable and suitably-shaped metal removal elements are provided to achieve the object. However, it has proven to be advantageous to design the removal element in the form of a scraper blade directed at its end towards the printing cylinder, and in fact as these are used in the machining of metal parts via scraping.

Normally, the metal removal element continuously rests against the printing cylinder in the processing of the printing cylinder by means of laser light to form the cups, and in fact the removal element rests against the printing cylinder by means of a suitably-adjusted force that, among other things, also applies to the regular metallic material of the printing cylinder in which the cups are formed. However, since the removal element wears away in the course of its removal activity, it is advantageous to design the removal element controlled with regard to application on the printing cylinder, such that the wear can be taken into account during the engraving event of the printing cylinder and can be continuously applied on the printing cylinder with suitable control and with uniform pressure. For exchange and adjustment, it can be advantageous to also develop the removal element such that it can be moved away from the printing cylinder.

In a further advantageous embodiment of the device, due to a spring force the removal element is supported on the surface of the printing cylinder via a support element with which the factor can be accounted for that the removal element can, for example, not move uncontrolled relative to the surface of the printing cylinder as a consequence of a wear during the intended operation as well as the possible variation of the scraper angle as a consequence of said wear, and said printing cylinder is not possibly consequently damaged.

In order to prevent that the support element itself damages the surface of the printing cylinder, it can be advantageous to design the support area of the support element from a hard material with good sliding properties, or even to form the support surface from diamond.

In principle, it can be reasonable to subsequently polish or grind the corresponding regions of the surface of the printing cylinder that have been directly engraved and whose melt accumulation has been remedied by the removal element of the preferred embodiment, i.e. to at least reproduce the original quality of the surface of the printing cylinder before execution of the engraving. A polishing element that polishes the region of the removed melt accumulation can thus be arranged immediately following the region of the metal removal element in the rotation direction of the printing cylinder. In another advantageous embodiment of the invention, the metal removal element is itself designed in the form of a polishing element, i.e. the melt accumulation is removed via polishing, whereby a separate, additional polishing event after the removal event can be omitted.

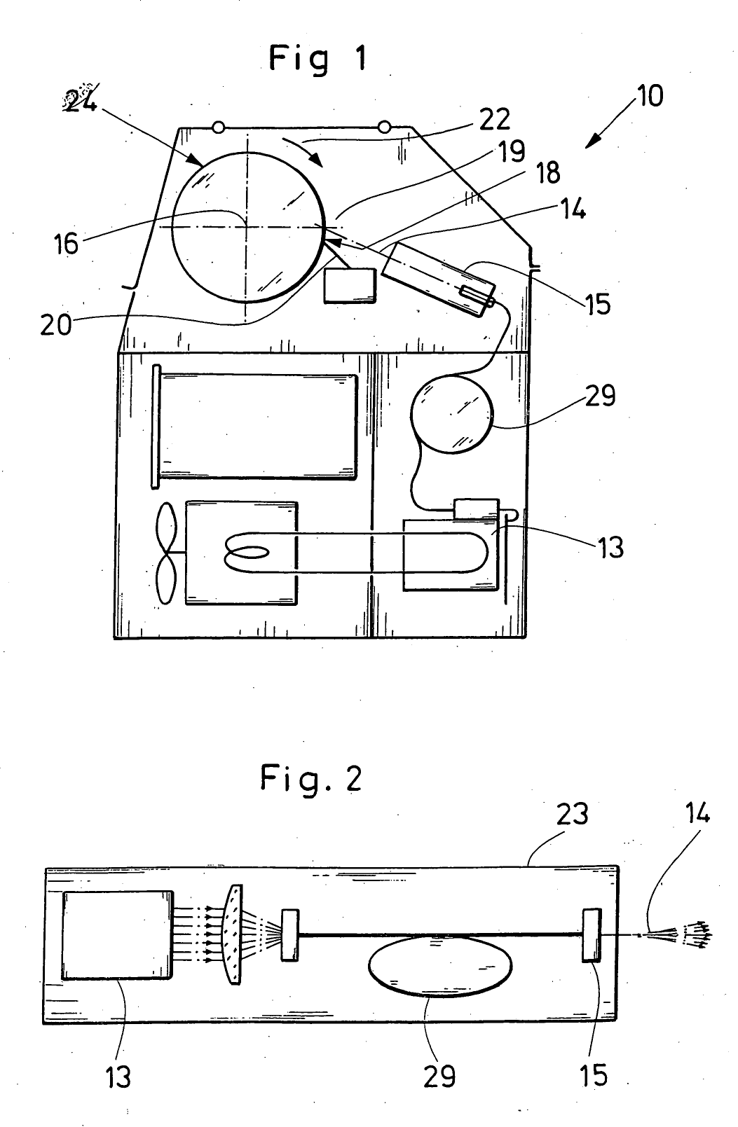

Reference is first made to the representation of FIG. 1, which shows in cross-section a device 10 for engraving of cups 11 into a printing cylinder 12 for rotogravure. A laser light source 13 by means of which laser light 14 is generated to form the cups 11 is provided in the device 10. The printing cylinder 12 can be actuated by means of an actuation device (not shown here) and is rotated in its intended rotation with intended rotation speed in the direction of the arrow 22, which indicates the rotation direction of the printing cylinder 12. The axis 16 of the printing cylinder is held in a suitable manner by means of a bearing (not shown here) in device 10. The fundamental design of such a device 10 is known in the prior art, such that it is not necessary to go into it further here.

In the embodiment of the device 10 shown in FIG. 1, the laser light source 13 is arranged offset from the region of the impingement location 19 of the laser light 14, whereby the connection of the laser light source 13 with the output unit 15 from which laser light 14 exits suitably focused and collimated can occur via a light conductor 29 that, for example, can be designed as a fiber laser or as a simple light conductor (laser fiber) with the output unit 15.

A metal removal element 20 is arranged in the region 18, i.e. in the immediate proximity of the impingement location 19 of the laser light 14 on the printing cylinder 12, which removal element 20 is discussed further below in detail in connection with the function of the removal element 20.

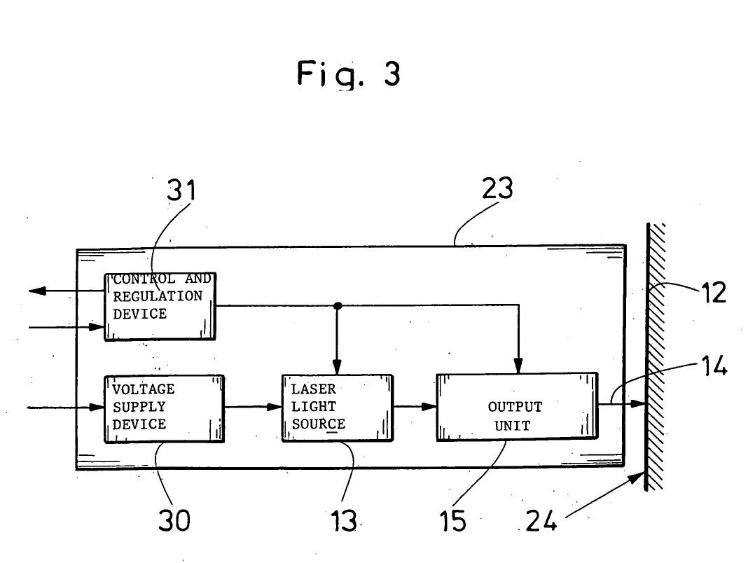

In a manner different than is shown in FIG. 1, the laser light source 13 and the output unit 15 of the laser light can also be combined into one unit 23 (compare FIGS. 2 and 3) such that not only (as in FIG. 1) the exit of the laser light source but rather the entire unit 23 can be moved dependent on the rotation of the printing cylinder 12 along the printing cylinder in its axial direction 17 (compare also FIG. 5). For movement in the axial direction 17 of the output unit 15, as shown in FIG. 1, or for movement of the unit 23 in which the exit 15 of the laser light 14 and the laser light source 13 are comprised, a carrier element 110 is provided as a type of support, which carrier element 110 bears this unit 23, whereby the carrier unit 110 is moved in an axial direction 17 along the printing cylinder 12. The movement of the output unit 15 or of the unit 12 occurs (dependent on the rotation of the printing cylinder 12) along the printing cylinder 12 in its axial direction 17, either by means of a constant feed such that from this a screw-shaped engraving track 27 results (which is discussed further below) (compare also FIG. 9), or a feed in the axial direction 17 by a predetermined amount, corresponding to the width of the track 27, respectively occurs after completion of a complete rotation of the cylinder 12, whereby fully-circular engraving tracks 27 are respectively formed.

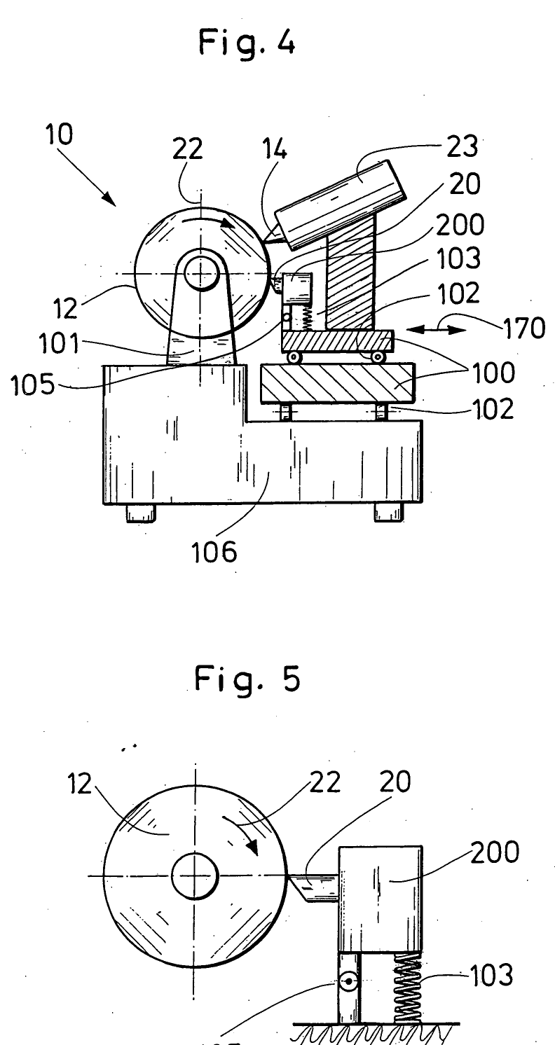

The device 10 is again shown in side view in FIG. 4, starting from the representation of FIG. 1 that significantly applies to the representation of the laser light source 13 as well as the exit of the laser light 14 from the output unit 15. The laser light source 13 is here designed as a unit 23. The unit 23 is arranged on a carrier element 100 that is designed as a type of support. The carrier element 100 can be moved both in an axial direction 17 and in a radial direction 170. The movement both in the axial direction 17 and in a radial direction 170 occurs along guides that can be designed as a sliding track and/or roller. The metal removal element 20 can be arranged on a head 200 on the part of the carrier element 100 that also bears the unit 23, whereby the head 200 can rotate around the joint 105 that exhibits a rotation axis significantly parallel to the axial direction 17. The head 200, and thus the removal element 20, can be pressed against the printing cylinder 12 by means of a spring element 103 with suitably-adjusted pressure. Due to the shifting capability of the carrier element in the radial direction 170 as well, the removal element 20 can also easily be adapted to differently-sized diameters of the printing cylinder 12. At the beginning of the removal event, of which more is discussed further below, the metal removal element 20 is shifted (with suitably adjusted pressure) into a desired position relative to the printing cylinder 12, such that when this is achieved and a suitable pressure of the removal element 20 is set, the removal event can begin.

FIG. 5 merely shows a sectional enlargement of FIG. 4.

The metal removal element 20 (compare FIGS. 1, 4 and 5) is, for example, designed in the form of a scraper, whereby the removal element 20 can be moved in a controlled manner for application on the printing cylinder 12 and away from this (not shown). The removal element 20 and, if applicable, its mounting and control mechanism, are moved either together with the unit 23 or the output unit 15 of the laser light 14 along the printing cylinder 12 in its axial direction 17. However, it is also possible to provide a separate guide or, respectively, for this a separate actuator for the removal element 20 including its application and pivot mechanism, by means of which guide the removal element 20 can be moved along the printing cylinder 12 in its axial direction 17. The removal element 20 can be provided with a support element 25 with which it can be supported on the surface 24 of the printing cylinder 12. The support surface 26 of the support element can be comprised of a suitable abrasion-proof material exhibiting good sliding properties, for example hard alloy carbide, for example or diamond. The removal element 20 can be designed in the form of a scraper, but also in the form of an abrasion element that can be tipped with diamond as an abrasion means, or also in the form of a polishing element.

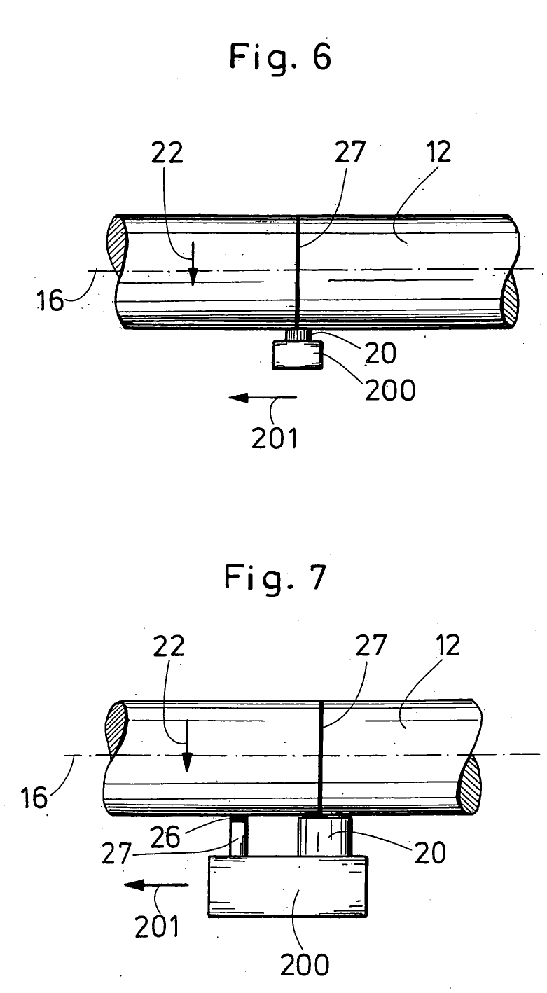

FIGS. 6 and 7 show in plan view, in a partial section, the interaction of the removal element 20 with the printing cylinder 12. The function of the removal element 20 in cooperation with the engraving event itself is described in detail further below.

The unit 23, of which either only the output unit 15 or the entire unit 23 itself can be moved along the axial direction 17 of the printing cylinder on the stated support, comprises the actual laser light source 13 that, for example, can be comprised of at least one laser diode, but can also be comprised of another suitable laser source. For operation of the laser light source 13, a supply voltage is supplied by a voltage supply device 30, whereby the laser light generated by the laser light source 13 (as indicated above) is fed to the output unit 15 that comprises an optical system (such as lenses and possibly diaphragms) in order to generate a suitably focused and possibly collimated beam of laser light 14, whereby the laser light 14 is fed to the surface 24 of the printing cylinder 12. This occurs by means of a control and regulation unit 31 that has embedded into the overall control a regulation function of the device 10. Since this control of the device 10 as well as the control and regulation of the unit 23 for the components listed in the preceding are known in the prior art, and at this point this is not further discussed.

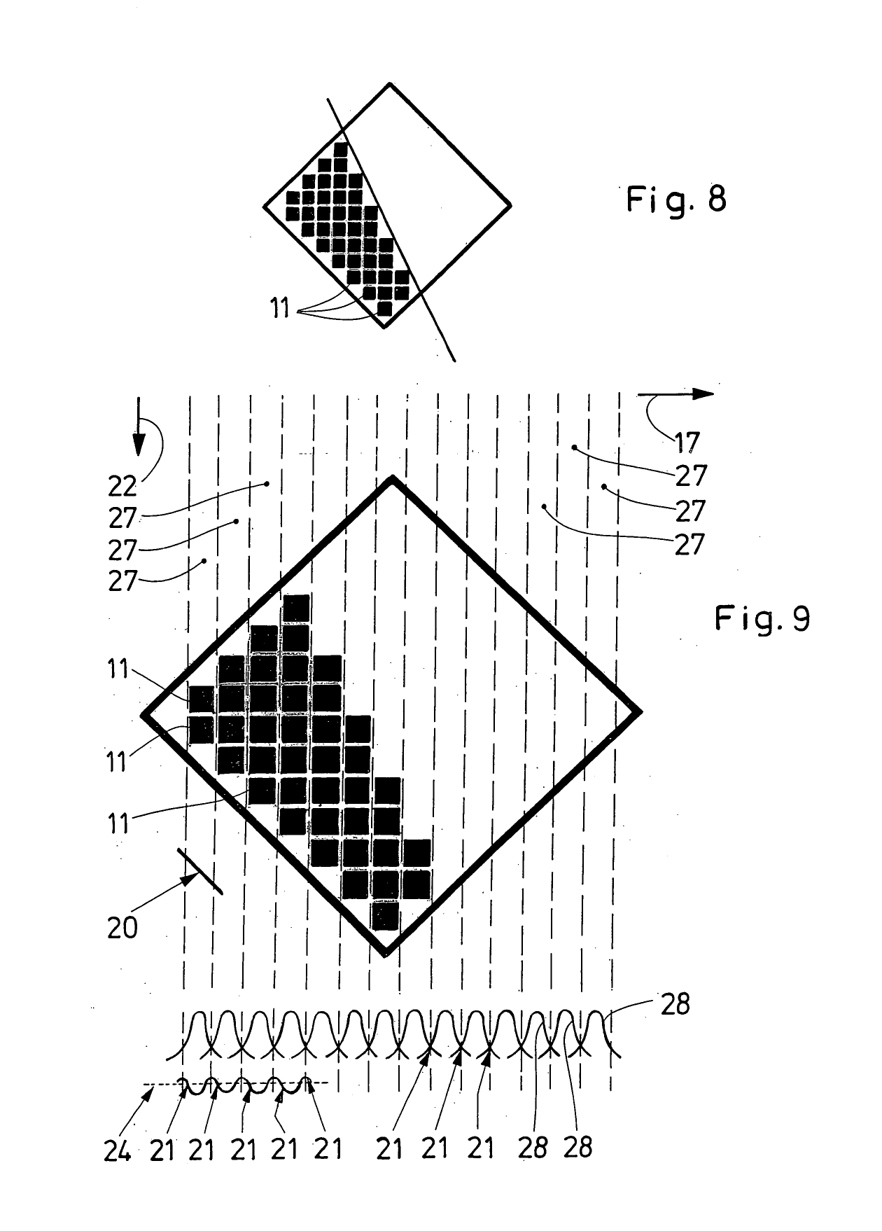

Reference is now made to the representations of FIGS. 8 and 9, whereby FIG. 8 shows an engraving pattern typical for formation of cups 11 in the surface 24 of the printing cylinder 12 for rotogravure in connection with a high-resolution direct laser engraving.

As already indicated above, the printing cylinder 12 rotates in the direction of arrow 22 in the execution of the engraving. The individual cups 11 in tracks 27 are thereby engraved in series in the rotation direction 22 for execution of the engraving.

In the image according to FIG. 9 below, the beam profile 28 of the laser beam 14 at the impingement location 19 on the printing cylinder 12 is shown. As is visible, the beam profiles 28 overlap from track 27 to track 27. Due to physical regularity, it is not possible to abruptly confine the beam profile 28 to the edges of the cups 11 as would, for example, be desirable given a cross-section with regard to the width of the beam, i.e. to aim for a rectangular course. Since this is not possible, the beam of the laser light 14 of the one track 27 influences the adjacent track 27, as this is likewise schematically indicated below in FIG. 9. Melt accumulations 21 made from the molten metal of the printing cylinder 12 are thus normally created in the respective border areas of the cups 11 and thus in each track 27 in the course of the engraving, track 27 for track 27, such that the cups in the preceding track are partially filled again with solidified printing cylinder material via the formation of the respective adjacent cups 11 of the respective adjacent tracks 27. In order to prevent this melt accumulation 21, the aforementioned metal removal element 20 is arranged in the region 18 of the impingement location 19 of the laser light 14 on the printing cylinder 12. The arrangement of the removal element 20 is selected such that the material of the printing cylinder 12, i.e. the melt accumulation 21, is removed immediately after its creation. The removal element 21 is arranged immediately following in the region of the impingement location 19 of the laser light 14 on the printing cylinder 12 in the rotation direction 22 of the printing cylinder 12, as is visible in FIG. 1 and clarified from FIG. 9.

In the preferred embodiment the melt accumulation 21 can be completely removed, independent of whether the metallic material of the printing cylinder 12 in which the cups 11 are engraved is copper, chromium, or zinc.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1. A device for engraving of cups into a rotary printing cylinder for rotogravure, comprising:
at least one laser light source with which laser light for formation of the cups is directed onto the rotary printing cylinder, an output unit of the laser light source being movable along the printing cylinder in an axial direction of the printing cylinder by a respective predetermined amount for a complete rotation of the printing cylinder; and
a metal removal element arranged in a region of an impingement location of the laser light on the printing cylinder to form the cups such that a melt accumulation of material of the printing cylinder which forms a burr at the cups created by the impingement of the laser light is removed substantially continuously and substantially immediately after its creation with said removal element.

2. A device according to claim 1 wherein the metal removal element is arranged immediately in a region of the impingement location of the laser light on the printing cylinder, following in a rotation direction of the printing cylinder.

3. A device according to claim 1 wherein at least the laser light source and the output unit of the laser light are moved in combination along the printing cylinder in its axial direction.

4. A device according to claim 3 wherein at least the output unit of the laser light and the laser light source are combined into one unit.

5. A device according to claim 1 wherein the metal removal element is moved along the printing cylinder, coupled in terms of actuation with at least the output unit of the laser light.

6. A device according to claim 1 wherein the metal removal element is designed in the form of a scraper at its end directed towards the printing cylinder.

7. A device according to claim 1 wherein the metal removal element is controlled for application on the printing cylinder and is moveable away therefrom.

8. A device according to claim 1 wherein the metal removal element is supported via a support element such that it glides on a surface of the printing cylinder.

9. A device according to claim 8 wherein the support element comprises a support surface comprised of diamond.

10. A device according to claim 1 wherein the metal removal element is designed in the form of an abrasion element.

11. A device according to claim 1 wherein at least a region of the surface of the printing cylinder in which the cups are formed is comprised of a metallic material.

12. A device according to claim 11 wherein the metallic material comprises copper.

13. A device according to claim 11 wherein the metallic material comprises chromium.

14. A device according to claim 11 wherein the metallic material comprises zinc.

15. A device for engraving of cups into a rotary printing cylinder for rotogravure, comprising:
at least one laser light source with which laser light for formation of the cups is directed onto the rotary printing cylinder, an output unit of the laser light source being constantly moved along the printing cylinder in an axial direction of the printing cylinder dependent on a rotation of the printing cylinder and is moved by a respective predetermined amount in said axial direction after completion of a complete rotation of the printing cylinder; and
a metal removal element arranged in a region of an impingement location of the laser light on the printing cylinder to form the cups such that a melt accumulation of material of the printing cylinder which forms a burr at the cups created by the impingement of the laser light is removed substantially continuously and substantially immediately after its creation with said removal element.

16. A device for engraving of cups into a rotary printing cylinder for rotogravure, comprising:
at least one laser light source with which laser light for formation of the cups is directed onto the rotary printing cylinder, an output unit of the laser light source being moveable along the printing cylinder in an axial direction of the printing cylinder; and
a metal removal element arranged in a region of an impingement location of the laser light on the printing cylinder to form the cups such that a melt accumulation of material of the printing cylinder which forms a burr at the cups created by the impingement of the laser light is removed substantially continuously after its creation with said removal element.
